(19) United States
(12) Patent Application Publication
(10) Pub. No.: US 2006/0015376 A1
(43) Pub. Date: Jan. 19, 2006

(54) Method and system for employee reservation of meeting rooms

(75) Inventors: Juergen Sattler, Wiesloch (DE); Joachim Gaffga, Wiesloch (DE)

Correspondence Address: KENYON & KENYON, 1500 K STREET NW, SUITE 700, WASHINGTON, DC, 20005, US

(73) Assignee: SAP Aktiengesellschaft

(21) Appl. No.: 11/044,209

(22) Filed: Jan. 28, 2005

Related U.S. Application Data
(60) Provisional application No. 60/588,591, filed on Jul. 16, 2004.

(51) Int. Cl. G06Q 10/00

(52) U.S. Cl. 705/5

(57) ABSTRACT

Embodiments of the present invention relate to a system for reserving a resource from a commonly available set of resources. A request from an employee to reserve a room in an office building at a date and time may be received at a first computer system. A reservation record that is associated with the requested room may be accessed in a database at the first computer system, and a determination may be made whether the room is available based on an indication in the reservation record of the room's status at the date and time requested. If the requested room is available, the reservation record associated with the requested room in the database at the first computer system may be updated to indicate that the room has been reserved at the date and time requested, and an account record associated with the requesting employee may be automatically updated to reflect a cost for the use of the reserved room.

### CROSS-REFERENCE TO RELATED APPLICATIONS

This application claims the benefit for purposes of priority to U.S. application No. 60/588,591, filed Jul. 16, 2004.

### BACKGROUND OF THE INVENTION

A business or other organization that uses a common set of rooms to conduct meetings and the like may coordinate the use of the rooms among the various parties wanting them. Computer software has been used to facilitate the coordination of room booking among multiple parties. Such software may utilize a database that is publicly accessible, for example, via a local area network. For example, using a “Groupware” feature of Microsoft Outlook® to read from and write to the shared database, multiple users can view and update a common list of resources, and thereby coordinate room bookings and avoid scheduling conflicts. As another example, software based on the known SAP (more completely, SAP Aktiengesellschaft) R/3® architecture is widely used and includes a room booking feature.

Currently, an employee in an organization may book rooms without incurring any cost. Thus, an employee may reserve a room that he or she does not need or may fail to cancel a reservation even though a meeting that was to take place in the room has been cancelled. It would be advantageous to be able to perform room bookings so as to facilitate the inter-corporate cost charging for rooms, and items used in meetings, that are booked by an employee. The present inventors have perceived these and other needs in the art.

### BRIEF DESCRIPTION OF THE DRAWINGS

FIG. 1 shows a simplified block diagram of an arrangement for reserving meeting rooms according to embodiments of the present invention.

FIG. 2 shows a simplified block diagram of computer systems with associated reservation and cost data according to embodiments of the present invention.

FIG. 3 shows a simplified block diagram of a reservation screen and order forms according to embodiments of the present invention.

FIGS. 4a & 4b show examples of data flow for reserving meeting rooms and synchronizing reservation data between two systems according to embodiments of the present invention.

FIG. 5 shows a process flow arrangement for reserving meeting rooms according to embodiments of the present invention.

### DETAILED DESCRIPTION

Embodiments of the present invention relate to software for reserving a shared or commonly available resource, where reservation of the commonly available resource may be performed by software executing on a computer system. In embodiments, the reservation of the commonly available resource may constitute booking a room or rooms out of a commonly available set of rooms, and such a booking may automatically result in an internal accounting charge being made against an account for the employee, the employee's work group, the employees cost center, etc. It may be understood that the examples discussed below are for illustration purposes only and are not intended to limit the configuration to that shown.

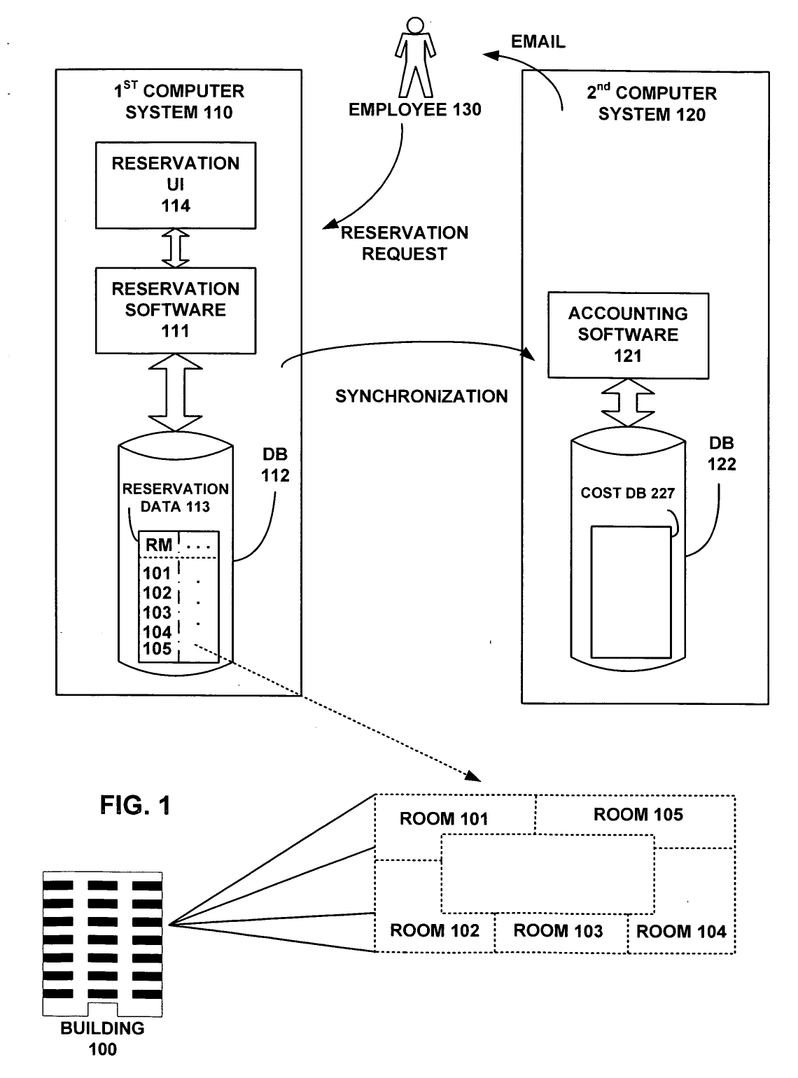

FIG. 1 shows a block diagram of an arrangement for reserving meeting rooms according to embodiments of the present invention. FIG. 1 shows a building 100, a first computer system 110, a second computer system 120, and an employee 130. As shown, building 100 contains a set of rooms 101-105. Building 100 is for illustration purposes, and embodiments of the disclosed invention could of course be used with other buildings, with rooms in multiple buildings, etc. In embodiments, employee 130 is an employee of an organization that controls (e.g., owns, rents, etc.) rooms 101-105 in building 100. In embodiments, rooms 101-105 are conference rooms which may be reserved by an employee of the organization for use for meetings or other functions. In some embodiments, employee 130 may send a room reservation request to first computer system 110. As used herein, the term “employee” refers to any member of an organization.

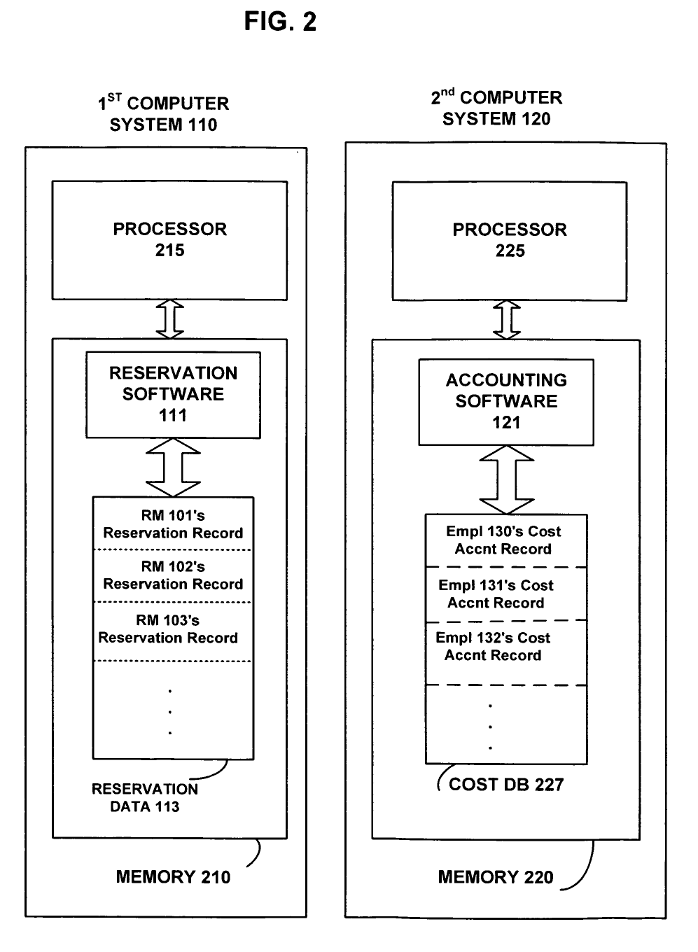

First computer system 110 and second computer system 120 represent both computer-executable instructions and the physical components necessary to execute the instructions. As shown in FIG. 2, such physical components may include a processor, memory coupled to the processor to hold computer-executable instructions for execution by the processor, and a memory device such as a disk to store the computer-executable instructions for retrieval into the memory for execution by the processor, and to store data to be operated on by the instructions. The physical components could form first and second distinct computer systems (e.g., distinct processor/memory and peripheral arrangements) that could be linked, for example, via a network, and communicate with each other via the link.

As shown in FIG. 1, first computer system 110 includes reservation software 111, a database 112 including reservation data 113, and a reservation user interface (UI) 114. Reservation software 111 may execute on a processor in first computer system 110 to reserve rooms 101-105 for use by employees. Reservation software 111 and database 112 may be stored electronically on a machine-readable medium such as a disk. The reservation data 113 may be accessible to a plurality of users, for example via a network. Accordingly, first computer system 110 might automatically perform such operations as checking for whether two or more users are attempting to book the same resource at the same time, and issuing an error message or other alert if there is a conflict. In some embodiments, reservation software 111 is a groupware application which may be executing on a processor, database 122 includes groupware data, and reservation user interface 114 may be a groupware user interface. In some embodiments, reservation software 111 may include a commercially available groupware program as well as an add-in module or modules that customize the groupware program to perform room reservation. As would be understood by a person of skill in the art, groupware is software that helps groups of colleagues who are attached to a network organize their activities, and examples are Microsoft Outlook®, Lotus Domino®, etc. An employee, such as employee 130, may access reservation software 111 through reservation user interface 114. Typically, a group of users who are connected through a network (such as a local area network) would all have access to copies of reservation software 111 and would each make changes to a common database such as database 112.

Reservation data 113, which is stored in database 112, may include a plurality of reservation records associated with the reservation status of rooms, such as rooms 101-105, or other kinds of resources available for booking at a given facility, such as an office building. Reservation data 113 may further include a list of persons authorized to reserve a room or other resource, a current schedule of reservations, and the like. Reservation software 111 may read and write reservation data 113. More specifically, first computer system 110 may, for example, read pre-existing reservation data 113 in response to queries from a user, entered via reservation user interface 114 (which may be shown on a display screen), and display the data for the user. In response to other operations by a user working with reservation software 111, first computer system 110 may update existing records in the reservation data 113, or write entirely new records in the reservation data 113. The updated or new records may be to update or make new reservations.

Second computer system 120 may perform accounting and other related functions within employee 130's organization. In some embodiments, second computer system 120 may be an enterprise resource planning (ERP) system. Second computer system 120 may be, for example, an SAP R/3® system and may store R/3® transaction data. As shown in FIG. 1, second computer system 120 may contain accounting software and a database 122 that includes a cost database (DB) 127.

According to some embodiments of the present invention, after a room is reserved by first computer system 110, a message is sent to second computer system 120, which may update a cost record in cost database 227 to reflect an internal charge for that room. This is represented in FIG. 1 by the directed line labeled “SYNCHRONIZATION”. In the synchronization, whenever new or changed reservation data is generated by first computer system 110, the new or changed reservation data may be automatically transmitted to second computer system 120 and applied to reservation data of second computer system 120. In synchronization, a new or changed record generated by, for example, a user's request to reserve a resource using first computer system 110, in addition to being applied to the reservation data 113 of first computer system 110, is automatically transmitted to second computer system 120 so that a cost database 227 may be updated to reflect an internal charge for the reserved room.

FIG. 2 shows a simplified block diagram of computer systems with associated reservation and cost data according to embodiments of the present invention. In particular, FIG. 2 shows first computer system 110 as containing a processor 215 and a memory 210 and second computer system 120 as containing a processor 225 and a memory 220. Processors 215 and 225 may be any type of processor, and memories 210 and 220 may be any type of memory devices and may include one or more memory storage units. As shown, memory 210 stores reservation software 111, which may be a computer program or collection of programs comprising computer-executable instructions according to embodiments of the present invention. Memory 220 stores accounting software 121. Memories 210 and 220 may be machine-readable mediums such as disks (e.g., “hard” or “fixed” disk). Other machine-readable media that the instructions may be stored on include “floppy” disk, CD-ROM, magnetic tape, RAM, etc. The computer-executable instructions may be executed by a processor to effect any of the features and/or processes described above. The computer-executable instructions may be distributed across a plurality of media, such as on physically separate storage devices respectively associated with physically separate computer systems that may communicate via a network. The functionality disclosed hereinabove may find specific implementations in a variety of forms, which are considered to be within the abilities of those of ordinary skill in the pertinent art after having reviewed the specification.

As shown in FIG. 2, memory 210 also stores reservation data 113 which includes a plurality of room reservation records, such as a room 101 reservation record, a room 102 reservation record, a room 103 reservation record, etc. Each room reservation record may contain information such as a room identifier and an indication whether the room is available at defined blocks of time. Memory 220 stores cost database 227, which may include a plurality of account records with information relating to costs incurred by an employee or group within an organization, such as an account record for employee 130, an account record for an employee 131, an account record for an employee 132, etc. In other embodiments, cost database 227 may include records that each show costs incurred by a group or cost center within the organization. According to embodiments of the present invention, the costs recorded may include the cost of an employee reserving a conference room. Providing the cost data associated with booking a resource may enable the cost to be automatically accounted for in the appropriate records, for example by a cost-charging or accounting system that communicates with the reservation software. The cost charging system could, for example, charge the cost to an internal account, to a customer account, or to a cost center.

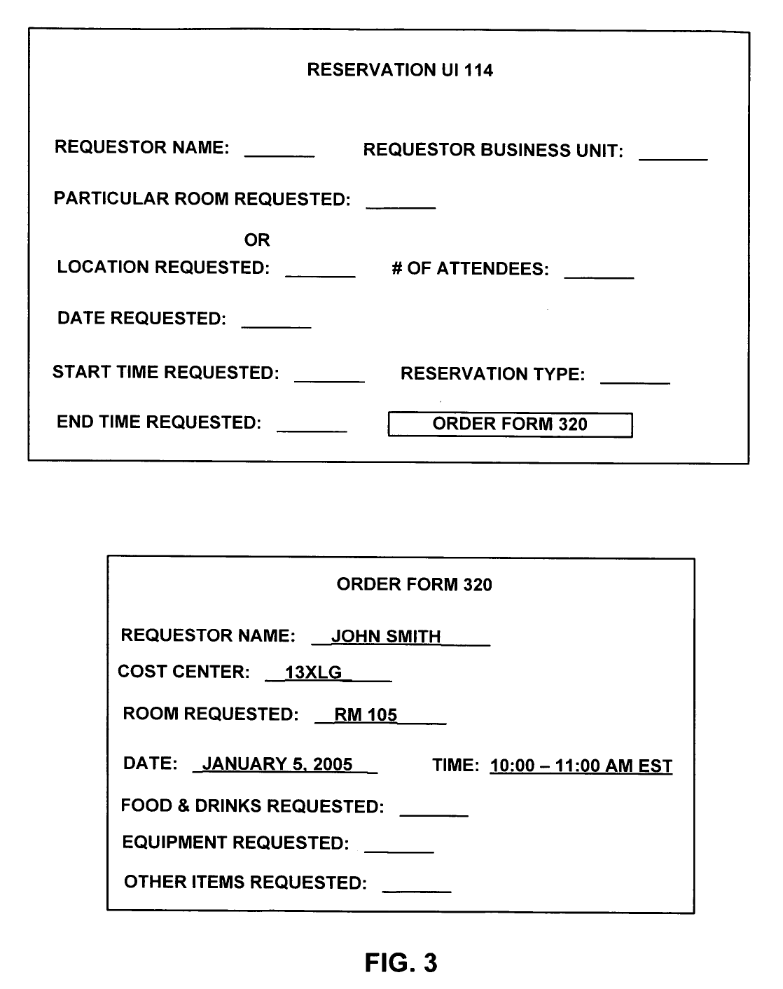

FIG. 3 shows a simplified block diagram of a reservation user interface 114 and an order form 320 according to embodiments of the present invention. Room reservation user interface 114 may used by an employee in order to request the reservation of a room. Room reservation user interface 114 may be displayed on a screen of 1^{st} computer system 110. As shown, room reservation user interface 114 may receive information such as the requestor's name and business unit, the room requested, the location (e.g., building, floor) that is being requested, the number of attendees at a meeting, the date and times requested, etc. The type of meeting may also be specified, such as an interview, training course, internal meeting, external meeting, telephone conference, party, etc. In some embodiments, before a room reservation is finalized, a room reservation fee may be displayed to the requestor. In some embodiments, a series of reservations might be made and/or a previous room reservation may be duplicated (with a new date or time). In the embodiment shown, reservation user interface 114 contains a link to order form 320. Of course, a user may be able to update or modify a room reservation at a later time. In some embodiments, some rooms might only be reserved by selected employees, such as members of the board of directors.

In some embodiments, order form 320 may be an electronic form that is automatically sent to a user to allow the user to order items that may be used at a meeting to be held in the reserved room, such as food and drinks, projection equipment, Internet hookups, number of chairs needed, etc. As shown, order form 320 may include information such as the requestor's name and cost center, the room requested, the date and time requested, and the items to be provided. In some embodiments, the cost may be allocated to a client charge account.

Of course, in other embodiments these forms may contain different or additional information. For example, other information that may be provided may be the identification of an event to be conducted in the room, a customer name, a catering service, authorization to enter the room, an access device, a classification of a meeting to be conducted in the room, and equipment for the room. In some embodiments, the requestor may specify whether access to the room is to be public or restricted. In addition to the blank fields shown in FIG. 3, other mechanisms for capturing information, such as pull-down menus, may of course be used.

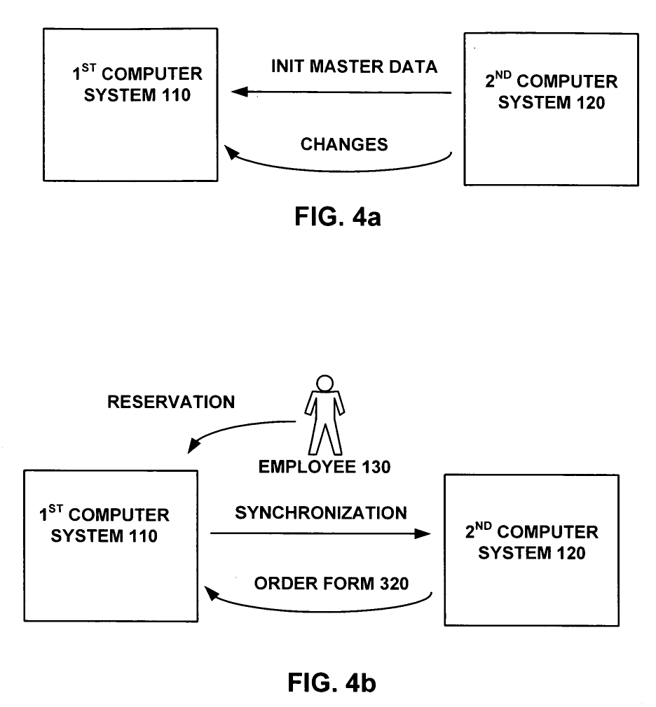

FIGS. 4a & 4b show examples of data flow for reserving meeting rooms and synchronizing reservation data between two systems according to embodiments of the present invention. FIGS. 4a & 4b show first computer system 110 and second computer system 120 of FIGS. 1-2, and FIG. 4b also shows employee 130. As shown in FIG. 4a, second computer system 120 may send to first computer system 110 an initial copy of the reservation data that is being maintained by first computer system 110. Such an exchange may take place when the systems are first installed, after maintenance has been performed, or periodically to verify the correspondence of the data. At a later time, second computer system 120 may send a message to first computer system 110 regarding changes in the reservation data, for example if a new room is made available (added) or if a room is made unavailable (due to construction, etc.). In this embodiment, the change information may be sent to reservation software 111 in first computer system 110.

As shown in FIG. 4b, employee 130 may send a request to first computer system 110 to request reservation of a room, for example using room reservation interface 114 of first computer system 110. First computer system 110 may then reserve the room in its database and may send a synchronization message to second computer system 120 indicting that this room has been reserved, and may send to second computer system 120 a synchronization message indicating that a room has been reserved. Upon receipt of the synchronization message, second computer system 120 may send an order form to employee 130, such as order form 320, that allows the employee to order items that are to be provided at the room during the reserved time, such as food. First computer system 110 may pre-populate order form 320 with information such as the room that was reserved, the person reserving the room and his/her cost center, the date and time of the reservation, etc. In another embodiment, employee 130 may access order form 320 from reservation user interface 114.

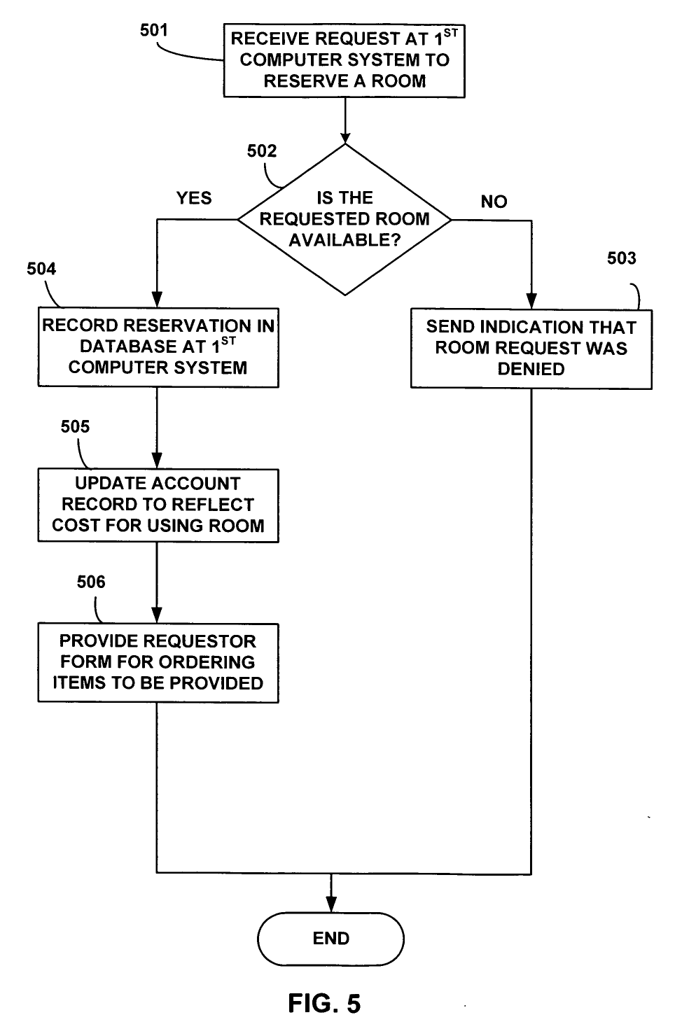

FIG. 5 shows a process flow arrangement for reserving meeting rooms according to embodiments of the present invention. For illustration purposes, the method shown is discussed with reference to the embodiments shown in FIGS. 1-4. According to the method shown, a first computer system may receive a request to reserve a room (501). For example, as shown in FIG. 4b, employee 130 may have made a request at reservation user interface 114 to reserve room 101 of building 100, and this request may be processed by reservation software 111. A determination may be made if the requested room is available for reservation at the data and time requested (502). For example, reservation software 111 may determine from reservation data 113 whether the room has previously been reserved at the requested date and time. For example, first computer system 110 may access a reservation record in database 112, such as the room 101 reservation record shown in FIG. 2, that is associated with the requested room and may determine whether the room is available based on an indication in the reservation record of the room's status at the date and time requested. If the requested room is not available for reservation at the date and time requested, a message may be sent to the employee indicating that the request was denied (503).

If the room is available, a room reservation may be made in a database at the first computer system (504). For example, the appropriate room reservation record in reservation data 113 may be updated to indicate that room 101 has been reserved by employee 130 at the requested date and time. An account record in the first computer system that is associated with the requesting employee may be updated to reflect a monetary cost for the use of the reserved room (505). For example, a cost account record in cost database 227 may be updated to charge the employee who requested use of the room. In other embodiments, the cost record associated with the requesting employee may be an account for the employee's group, business unit, etc. The cost would typically be an “artificial” cost such an internal accounting charge that reflects the costs to the organization for maintaining the room, and a bill would not be sent to the employee. The first computer system may then automatically send the employee an order form, such as order form 302, that allows the employee to order items to be provided at the reserved date and time (506). Such an order form may be sent to the employee, for example, by electronic mail (“e-mail”). In some embodiments, the first computer system may receive a completed order form from the employee, such as order form 320, that specifies items to be provided in the room at the reserved time (e.g., food, drinks, etc.) and the first computer system may then update the account record associated with the requesting employee to reflect a monetary cost for the items to be provided.

In some embodiments, first computer system 110 may receive information (i.e., from a building manager) indicating either that a room in the office building is no longer available for employee reservation or that a new room in the office building is being made available for employee reservation, and may send a message to the second computer system 120 to indicate that the change has occurred. In some embodiments, either first computer system 110 or second computer system 120 may automatically request confirmation from a user at some point (e.g., the day of the reservation) as to whether the reservation is to be kept.

In some embodiments, reservation software 111 may be adapted to work with data formats and structures that are different from data formats and structures that reservation software 121 is adapted to work with. Accordingly, embodiments of the present invention may further comprise computer-executable instructions to translate or convert data transmitted from first computer system 110 to a data format usable by second computer system 120, and vice versa. Thus, when change data is transmitted from first computer system 110 to second computer system 120 or vice versa to be applied to the corresponding reservation database, the change data may be converted to the appropriate format.

In some embodiments, an employee may specify documents that are to be provided to attendees of a meeting that is to be held in the room during at the date and time that the room is being reserved. These documents may be stored as electronic documents in first computer system 110 and may be sent to a list of meeting attendees that are specified by the employee that is reserving the room. In some embodiments, the documents may be sent as soon as possible or at a specified time in the future (e.g., the day of the meeting).

In embodiments of the present invention, a single operation may be used to book resources in both first computer system 110 and second computer system 120. More specifically, in order to further reduce the need for a user to be trained in two different user interfaces for booking resources, a common operation that can be called up on both systems may be provided according to embodiments of the present invention. For example, a button or other input or interactive field on a screen display of a user interface could be provided that, when clicked on or otherwise receiving a user input, would call up a form for booking resources that was identical for either system. While the underlying software, data formats and even hardware platform might still be different between the two systems, the appearance of the form would be the same, and this could simplify usage.

Embodiments of the present invention may further comprise automatically appending to or associating with a reservation auxiliary information relating to the reservation. For example, basic information describing a reservation of a room might include the location of the room and the start and end times of the reservation. Auxiliary information relating to the reservation could include, for example, event information, such as the information that the room is being reserved for lunch (or breakfast or dinner or other event/meal) with a customer, and the customer name. In embodiments, the customer name may be selected from a “Contacts” list in Microsoft Outlook®. Alternatively, a customer could be selected from a database external to Outlook®. The auxiliary information could further include, for example, details of a catering service to be provided, or details about authorization to enter the room or restricted or controlled-access areas. In connection with the latter, for example, the auxiliary information might request the issuance of access cards (e.g., the magnetic devices sometimes known as “key cards”) to a selected group of visitors. The auxiliary information may further include, for example, a classification of a meeting (e.g., entertaining a customer, conducting internal business, or the like). The classification could be selected from a drop-down list, for example. The auxiliary information may further include, for example, details about the kind of equipment needed for a meeting, such as the number of seats needed, audio-visual equipment needed, and the like.

The auxiliary information relating to the reservation could be entered, for example, via a form. Along lines discussed earlier, the form could be generated in a screen display of a user interface in response to, for example, clicking on a button or otherwise entering user input by way of an input or interactive field. Information entered into the form could be stored on a database, and transferred between two systems in a synchronization process as described above.

Embodiments of the present invention may further comprise automatically notifying users about changes in resource availability. For example, an electronic mail message, or “e-mail”, could automatically be sent to a user who had reserved a room but the room unexpectedly became unavailable. More generally, an e-mail could be broadcast to all users notifying the users of a resource, such as a room, that is no longer available, or of a newly available resource, such as a new meeting room. Along similar lines, a reminder e-mail could be sent periodically or at some predetermined time before the utilization of a reserved resource, such as a room, asking for confirmation that the user still wants to use the resource. Such an e-mail might say, for example: “Please confirm (Y/N) that you want to keep your reservation of room XYZ on March 3rd at 10:00 AM.” If the user replied in the negative, the reservation would be canceled and the room freed up for another user. A notification of a cancellation might also be sent to a cost charging system that communicates with the reservation software, to avoid incurring a cost charge for the room.

According to still further embodiments of the present invention, an e-mail could be sent to a user to ask the user whether the room he/she wants to reserve is public or private, or is otherwise to have restricted access. A pop-up window could be provided whereby the user could change the type of access (public or restricted), or the user could simply be reminded that there is a security issue involved. In alternative embodiments, a user could simply be required to specify a type of access in the ordinary course of booking a room. If the meeting is private, any documents being provided may be protected so that only authorized users would have access to those documents.

A “search” operation may further be provided according to embodiments of the present invention. In the search operation, search criteria may be entered by a user, and a resource or resources may be selected in the search based on the criteria. For example, the search criteria might request a search operation to search for all meeting rooms, all free meeting rooms, all occupied or reserved meeting rooms, or for a meeting room or rooms in a particular location (e.g. a building or city). The search operation may be performed by way of a user interface, for example. Results of the search operation may be returned in the form of list, for example, of those elements meeting the search criteria. An employee may be able to select rooms in a particular city, at a particular campus, in a combination of buildings, in a particular building, etc. In some embodiments, an employee that has previously reserved a room may be able to request that the room reservation be switched with another room. A search function may allow the employee to locate an equivalent room (which may be either available or reserved) for the purposes of a switch.

In some embodiments, a requestor may also specify event management criteria, such as a request for name tags for meeting participants, access cards for meeting participants, etc. In some embodiments, the requestor may specify the name(s) of the persons who are to attend the meeting.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method comprising:
receiving at a first computer system a request from an employee to reserve a room in an office building at a date and time;
accessing in a database at the first computer system a reservation record that is associated with the requested room;
determining whether the room is available based on an indication in the reservation record of the room's status at the date and time requested;
if the requested room is available, performing the following:
updating the reservation record associated with the requested room in the database at the first computer system to indicate that the room has been reserved at the date and time requested; and
automatically updating an account record associated with the requesting employee to reflect a cost for the use of the reserved room.

2. The method of claim 1, wherein the method further comprises:
automatically providing the requesting employee an electronic form for ordering items to be provided in the room at the time reserved.

3. The method of claim 2, wherein the method further comprises:
receiving back from the employee the electronic form containing an order for items to be provided in the room at the time reserved; and
updating the account record associated with the requesting employee to reflect a cost for the items to be provided.

4. The method of claim 3, wherein the items to be provided in the room at the time reserved comprise food to be served at a meeting.

5. The method of claim 1, wherein said automatically updating an account record comprises sending a message to a second computer system indicating that an account record should be updated.

6. The method of claim 5, wherein the second computer system is an enterprise resource planning system.

7. The method of claim 1, wherein the method further comprises sending an e-mail message to the employee that reserved the room requesting that the room reservation be confirmed.

8. A machine-readable medium storing a set of instructions, the set of instructions capable of being executed by a processor to implement a method comprising:
receiving at a first computer system a request from an employee to reserve a room in an office building at a date and time;
accessing in a database at the first computer system a reservation record that is associated with the requested room;
determining whether the room is available based on an indication in the reservation record of the room's status at the date and time requested;
if the requested room is available, performing the following:
updating the reservation record associated with the requested room in the database at the first computer system to indicate that the room has been reserved at the date and time requested; and
automatically updating an account record associated with the requesting employee to reflect a cost for the use of the reserved room.

9. The machine-readable medium of claim 8, wherein the method further comprises:
automatically providing the requesting employee an electronic form for ordering items to be provided in the room at the time reserved.

10. The machine-readable medium of claim 9, wherein the method further comprises:
receiving back from the employee the electronic form containing an order for items to be provided in the room at the time reserved; and
updating the account record associated with the requesting employee to reflect a cost for the items to be provided.

11. The machine-readable medium of claim 10, wherein the items to be provided in the room at the time reserved comprise food to be served at a meeting.

12. The machine-readable medium of claim 8, wherein said automatically updating an account record comprises sending a message to a second computer system indicating that an account record should be updated.

13. The machine-readable medium of claim 12, wherein the second computer system is an enterprise resource planning system.

14. The machine-readable medium of claim 8, wherein the method further comprises sending an e-mail message to the employee that reserved the room requesting that the room reservation be confirmed.

15. A system comprising:
a storage unit to store a plurality of records that each contain reservation data for a plurality or rooms;
a storage unit to store a plurality of cost records that assign a cost to an entity for the use of a room in an office building; and
a means for processing a request to reserve a room in the office building, wherein if processing the request results in reservation of a room, the processing includes updating a cost record to assign a cost to an entity for the use of the room.

16. The system of claim 15, wherein the system further comprises a means for extracting data from an electronic order form and causing items specified on the form to be provided in the room at a date and time that the room is reserved.

17. The system of claim 15, wherein the means for processing a request to reserve a room is configured to generate an email message to a person associated with the reservation requesting confirmation that the room has been reserved.

18. The system of claim 15, wherein the means for processing a request to reserve a room is configured to send electronic documents to a list of persons that are specified as attending a meeting to be held in the reserved room.

19. The system of claim 15, wherein the means for processing a request to reserve a room is configured to process event management criteria that are specified with the request.
